(19) United States
(12) Patent Application Publication
(10) Pub. No.: US 2023/0203379 A1
(43) Pub. Date: Jun. 29, 2023

(54) PROCEDURE FOR OBTAINING FLEXIBLE EXPANDABLE MATERIAL (FEM) RESISTANT TO COMBUSTION USING BIOPLASTIFICIZERS

(71) Applicant: SMARTFIREBLOCK DOO BEOGRAD-CUKARICA, Beograd-Cukarica (RS)

(72) Inventors: Branko Ljubisavljevic, Beograd (RS); Tijana Ljubisavljevic, Beograd (RS); Nemanja Subotic, Beograd (RS); Aleksandar Marinkovic, Beograd-Becmen (RS); Natasa Tomic, Beograd (RS); Marija Vuksanovic, Beograd (RS); Luka Milosevic, Beograd (RS)

(21) Appl. No.: 17/926,576

(22) PCT Filed: May 20, 2021
(86) PCT No.: PCT/RS2021/000005

§ 371 Date: Nov. 18, 2022

(30) Foreign Application Priority Data
May 20, 2020 (RS) P-2020/0594

(51) Int. Cl. C09K 21/14; C08J 9/00; C08J 9/10; F16L 5/04

(52) U.S. Cl. CPC C09K 21/14; C08J 9/0023; C08J 9/103; F16L 5/04; C08J 2327/06; C08J 2331/04; C08J 2203/04; C08J 2205/06

(57) ABSTRACT

The present invention is a novel fire-resistant material used for the manufacturing of pipe collars as passive fire protection. The technological process consists of two phases. The first phase involves mixing poly (vinyl chloride-co-vinyl acetate) copolymers (VC-co-VAc) or a modified poly(vinyl chloride-co-vinyl acetate) copolymer (VC-co-VAc) with expandable graphite and plasticizers/modifiers such as: diisononyl phthalate—DINP, dioctyl adipate—DOA, 1-hexadecene or methyl esters of soybean fatty acids (MBS), azodicarbonamide (ADC), tri-p-cresyl phosphate, tri-m-cresyl phosphate or tri-o-cresyl phosphate, epoxidized soybean oil (ESO) and polyacrylate or poly(vinylacetate) emulsion. The second phase considers shaping the resulting mixture in a temperature-controlled press to make various samples, which are further tested. The samples had different dimensions: 4-6 mm thickness, 70-400 mm width and 240-500 mm length.

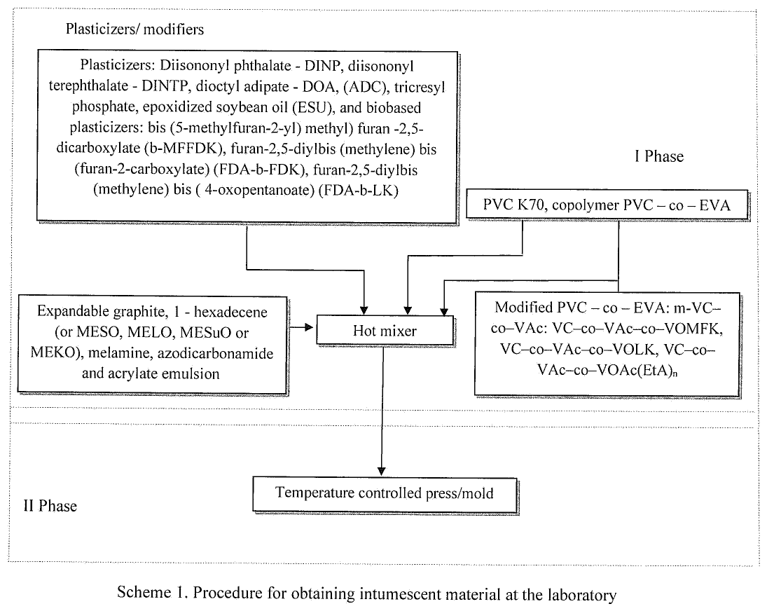

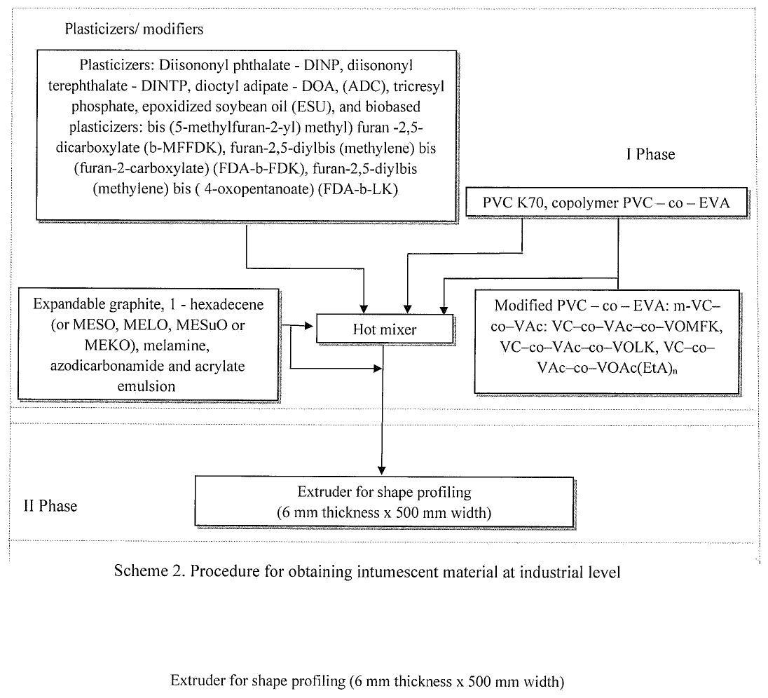

### TECHNICAL FIELD

The present invention relates to the field of chemical technology and relates to a process for the preparation of a material used for the manufacturing of pipe collars as passive protection against the spread of fire. According to the international classification of patents, it bears the following designations: C04B 111/28 and C08G 2/22.

### Technical Problem

The present invention belongs to the field of technology for the production of expandable material used as passive fire protection. There are various methods of fire protection, and among those methods is the use of expandable material that slows down the flame. The degree to which the fire-resistant expandable material (FEM) expands is an important property in a fire, because it must fill the intended space at high speed. The high degree of expansion allows the FEM to spread towards the perimeter of the opening to be sealed and thus provides effective protection against the spread of fire and smoke.

The scientific and patent's literature presents a numerous examples related to expandable materials that are commonly used in fire protection, and consists of:
binders (polymers of synthetic polyvinyl acetate, epoxy resins, etc. or of natural origin),
acid donor material and dehydrating agents (such as phosphorus salts—ammonium polyphosphate, polyphosphorus and its derivatives, sulfuric and boric acids, etc.),
blowing agents (expandable graphite, melamine and derivatives, urea, urea-formaldehyde resins, dicyanamide, melamine resins, etc.)
carbon donor (pentaerythritol and derivatives, cyan urates, carbohydrate base, polymers of synthetic or natural origin, etc.),
plasticizers (commercial: phthalate, adipate, citrate, etc. or on a bio-renewable basis),
catalysts (organic and inorganic salts),
inorganic fillers (metal oxides, organic salts, carbon materials, etc.),
flame retardants (phosphate esters, melamine, and cyan urate derivatives, etc.), and
nanomaterials (siloxanes, carbon materials, double layered hydroxide (LDHs, etc.).

When heated, the acid catalyzes the dehydration of carbon material. Expanders increase the volume of the material and build a networked spatial structure that has a low heat transfer coefficient. The structure formed is resistant to combustion and it is mechanically strong, which allows maintaining the integrity of the material in conditions of high temperatures.

In order to confirm the properties of the obtained materials, they are subjected to rigorous tests related to mechanical and elastic properties, expansion, combustion resistance, characteristics of volatiles (soot and toxicity), and impact on humans and environment. The main problems that occur during the production of these materials are related to achieving system compatibility, balance of mechanical and elastic properties, dimensional changes of materials during flame exposure with the formation of mechanically stable film, reduced emissions of toxic volatiles. One of the main challenges today related to the environmental protection is the use of bio-renewable raw materials for the production of FEM in order to meet the principles of circular economy.

### BACKGROUND OF THE INVENTION

A review of the available literature found that there are a number of applied technologies that are used to prepare expandable materials in the application of passive fire protection.

Patent CA2224325C, Intumescent sheet material, is an expandable sheet material consisting of 20-80 dry mass fractions of non-expandable material, 10-40 dry mass fractions of processed vermiculite, 0-5 dry mass fractions of inorganic fibers (Ø>5 μm) and 0-10 dry weight parts of organic fibers.

Patent CA2289372C, Intumescent material, discloses an expandable material comprising a liquid carrier with a corrosion inhibitor, expandable graphite and, if necessary, fillers. This material has a pH value higher than 7 in order to reduce the corrosive effect of the material on the metal substrate.

U.S. Pat. No. 4,883,062, Preparation of intumescent materials for coatings and building elements, provides a technology for producing a new expandable material by reacting of polyisocyanate with a condensation product containing phosphorus and at least two hydroxyl groups, boron oxide and/or a dehydrated boric acid product.

U.S. Pat. No. 5,113,2054, Composition of matter for afire retardant intumescent material having two stages of expansion and a process for making thereof, discloses obtaining a material of two-stage expansion. The material composition comprised primary expansion components such as expandable graphite in combination with a pre-expandable material that expands at a temperature lower than the primary expansion component. The pre-expandable component may be a liquid isobutane encapsulated in latex or polyvinylidene microspheres.

U.S. Pat. No. 6,609,9129, Elastomeric intumescent materials, discloses an elastomeric material derived from chlorinated polyethylene, plasticizers, phosphorus-based foaming agents, soot-forming agents, antioxidants, expandable materials, flame retardants and graphite, or expandable graphite. A hardener or catalyst may be added to improve the strength and stiffness of the material when exposed to fire.

Patent WO2006039275A2, Intumescent materials, discloses fire and heat resistant polymeric materials, which can be obtained from polyvinyl chloride with an expandable component. The expandable material also includes an expansion catalyst from the group of salts of phosphoric or sulfuric acid and a carbonaceous material from the group of starches, sugars, and alcohols obtained from sugars, oils and plasticizers. The material thus obtained can also be in the form of foam.

### Essence of the Invention

The essence of the present invention is the development of a new fire-retardant material used for the manufacturing of pipe collars as passive fire protection. Commercial and modified binders based on poly (vinyl chloride) (PVC), as well as commercial plasticizers/modifiers and the ones synthesized from bio-renewable resources were used. This material is manufactured according to defined process parameters such as temperature and mode of operation in order to achieve satisfactory mechanical properties and fire resistance in accordance to the relevant standards

According to the present invention, the technological process of obtaining fire-resistant material is performed as a two-stage process. Phase (I) refers to the mixing of: polyvinyl chloride (PVC), poly (vinyl chloride-co-vinyl acetate) copolymer (VC-co-VAc) or modified poly (vinyl chloride-co-vinyl acetate) copolymer (m-VC-co-VAc) with plasticizers/modifiers such as: diisononyl phthalate—DINP, diisononyl terephthalate—DINTP, dioctyl adipate—DOA, tri-p-cresyl phosphate (TpKP), tri-m-cresyl phosphate (TmKP), tri-o-cresyl phosphate (ToKP), or mixtures thereof, epoxidase soybean oil (ESU), as well as synthesized on the basis of biodegradable sources such as: bis (5-methylfuran-2-yl)methyl) furan-2,5-dicarboxylate (b-MFFDK), furan-2,5-diyl bis(methylene)bis(furan-2-carboxylate) (FDA-b-FDK), furan-2,5-diylbis(methylene)bis(4-oxopentanoate) (FDA-b-LK), 1-hexadecene or methyl esters of fatty acids, azodicarbonamide (ADC), melamine; polyacrylate or poly(vinylacetate) emulsion (Ecrylic, Flexryl or DH50, etc.) and expandable agents (expandable graphite (EG)). The mixture is added either to a hot mixer or during transport of the viscous mass to the extruder using a flow-controlled dispenser where the mass is homogenized and profiled in the desired shape.

Raw materials used in the preparation of fire-resistant material have the following properties:
Expandable graphite (EG): 3558 Asbury Carbons, USA
Appearance: Gray
Density: 2.09-2.23 g/cm³
Carbon content: 95˜99%
Particle size: 150 μm˜500 μm
Speed expansion: 150˜400 ml/g
pH value: 5.0-8.0
Polyvinyl chloride (PVC): CAS Number: 9002-86-2
Structural formula:

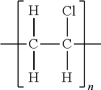

Melting point: 100-260° C.
Glass Transition Temperature: 82° C.
Effective heat of combustion: 17.95 MJ/kg
Specific heat: 0.9 κJ/(kg·κ)
K70: CAS Number: 9002-86-2
K-value: 70
Absolute density: 1470 kg/m³
Adsorption of plasticizers: 36%
Polyvinyl chloride-co-vinyl acetate Slovinyl KV-173: CAS Number: 9002-86-2, 9003-20-7
The content of VAc (%): ≥12
K-value: 48
Viscosity: 54-59 cm³/g
Diisononyl phthalate (DINP): CAS Number: 28553-12-0
Chemical formula: C₂₆H₄₂O₄
Structural formula:

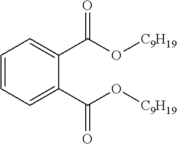

Molar mass: 418.61 g/mol
Density: 0.98 g/cm³
Melting point: −43° C.
Boiling point: 403° C.
Dioctyl adipate (DOA): CAS Number: 123-79-5
Chemical formula: C₂₂H₄₂O₄

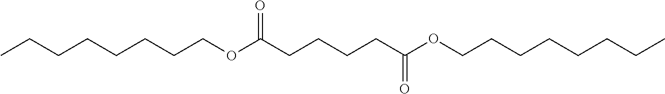 [SMILES: CCCCCCCCOC(=O)CCCCC(=O)OCCCCCCCC]

Molar mass: 370.57 g/mol
Appearance: Colorless to yellowish liquid
Density: 0.98 g/cm³
Melting point: −7.48° C.
Boiling point: 404.8° C.
Solubility in water: 0.78 mg/dm³ (na 22° C.)
1-Heksadecene: CAS Number: 629-73-2
Chemical formula: C₁₆H₃₂
Structural formula:

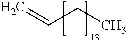

Molar mass: 224.42 g/mol
Appearance: Colorless
Density: 0.98 g/cm³
Melting point: 2.2° C.
Flash point: 132° C.
Boiling point: 274° C.

Alternatively, methyl esters of soybean oil (MESO) are used, namely methyl esters of the following acids: Palmitic ˜9 wt. %, Palmitolein ˜2 wt. %, Stearin ˜4 wt. %, Olein ˜22 wt. %, Linoleic ˜50 wt. %, Linoleic ˜9 wt. % And the rest ˜4 wt. %, acid number <5. Flaxseed methyl esters (MELO), sunflower (MESuO) and corn oil (MECO) can also be used.
Azodicarbonamide (ADC): CAS Number: 123-77-3
Chemical formula: C₂H₄N₄O₂
Structural formula:

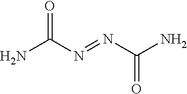

Molar mass: 116.08 g/mol
Melting point: 201-300° C.
Onset of decomposition in
dioctyl phthalate (DOP): ˜190° C.
Theoretical gas number: 193 cm³/g
Effective gas number: 220 cm³/g
Specific heat capacity: 1.09 KJ/kg K
Heat of combustion: 908.8 KJ/mol
Heat decomposition: 41.8 KJ/mol
Tri-o-cresyl phosphate (ToKP): CAS Number: 78-30-8
Chemical formula: C₂₁H₂₁O₄P
Structural formula:

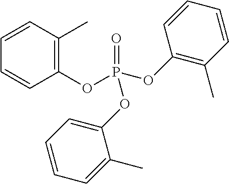 [SMILES: Cc1ccccc1OP(=O)(Oc1ccccc1C)Oc1ccccc1C]

Molar mass: 368.37 g/mol
Appearance: Colorless liquid
Melting point: −40° C.
Boiling point: 255° C.
Epoxidized soybean oil (ESO): CAS Number: 8013-07-8
Structural formula:

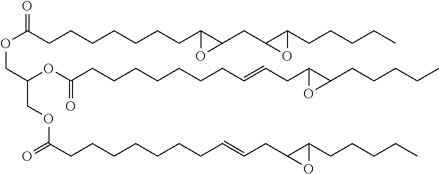 [SMILES: CCCCCC1OC1C/C=C/CCCCCCCC(=O)OCC(COC(=O)CCCCCCCC1OC1CC1OC1CCCCC)OC(=O)CCCCCCC/C=C/CC1OC1CCCCC]

Appearance: Light yellow viscous liquid
Density: 0.994 g/cm³ at 25° C.
Melting point: 0° C.
Flash point: 227° C.
Solubility: Absolute ethanol, ether, insoluble in water
Ethanolamine: CAS Number: 141-43-5
Chemical formula: C₂H₇NO
Structural formula:

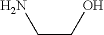

Molar mass: 61.08 g/mol
Density: 1.012 g/cm³
Melting point: 103° C.
Boiling point: 170° C.
Solubility in water: Miscible
Levulinic acid: CAS Number: 123-76-2
Chemical formula: C₅H₈O₃
Structural formula:

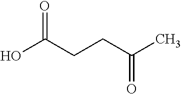

Molar mass: 116.11 g/mol
Density: 1.14 g/cm³
Melting point: 33-35° C.
Boiling point: 245° C.
Melamine: CAS Number: 108-78-1
Chemical formula: C₃H₆N₆
Structural formula:

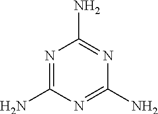

Molar mass: 126.120 g/mol
Appearance: White solid
Density: 1.57 g/cm³
Melting point: 345° C.
Solubility: Very slightly soluble in hot alcohol, benzene, glycerol, pyridine insoluble in ether
5-Methylfurfural: CAS number: 620-02-0
Chemical formula: C₆H₆O₂
Structural formula:

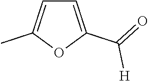

Molar mass: 110.11 g/mol
Appearance: Yellow to amber liquid
Boiling point: 187° C.
2,5-Furandicarboxylic acid: CAS Number: 3238-40-2
Chemical formula: C₆H₄O₅
Structural formula:

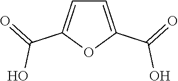 [SMILES: O=C(O)c1ccc(C(=O)O)o1]

Molar mass: 156.093 g/mol
Density: 1.6 g/cm³
Melting point: 342° C.
Boiling point: 420° C.
Solubility in water: Soluble in DMSO

Stabilizer used is Stabiol CZ 2680 Reagens Deutschland GmbH

According to the present invention, a technological process for the production of fire-resistant material, which is used for the production of pipe collars as passive fire protection, can be performed as a two-stage process. The production process was performed at the laboratory and industrial level.

According to the present invention, the technological process of obtaining FEM is performed as a two-stage process. Phase (I) refers to the mixing, at the laboratory and industrial level, of 10-50 wt. % of polyvinyl chloride (PVC), a copolymer of poly(vinyl chloride-co-vinyl acetate) (VC-co-VAc) or a modified copolymer of poly (vinyl chloride-co-vinyl acetate) (m-VC-co-VAc) or their two-component mixtures at a weight ratio of 0.1:1-1:0.1 is metered into a warm mixer and mixed with plasticizers/modifiers such as: 5-40 wt. % from the group of phthalates plasticizer: diisononyl phthalate—DINP, diisononyl terephthalate—DINTP, 0-20 wt. % dioctyl adipate—DOA, 0-20 wt. % tri-p-cresyl phosphate (TpKP), tri-m-cresyl phosphate (TmKP), tri-o-cresyl phosphate (ToKP), 0-10 wt. % epoxidized soybean oil (ESO), as well as synthesized on the basis of biorenewable sources (bioplasticizers) such as: 5-40 wt. % Bis((5-methylfuran-2-yl)methyl) furan-2,5-dicarboxylate (b-MFFDK), furan-2,5-diylbis(methylene)bis(furan-2-carboxylate) (FDA-b-FDK), furan-2,5-diylbis(methylene)bis(4-oxopentanoate) (FDA-b-LK), as well as mixtures thereof with phthalate plasticizer has at weight ratios of 0.1:1-1:0.1, as well as stabilizers 0.1-10%, 0-1 wt. % 1-hexadecene (or MESO, MELO, MESuO or MECO), 0-5 wt. % Azodicarbonamide (ADC), 0-10 wt. % melamine and 0-5 wt. % acrylate emulsion (DH50, Ecrylic, Flexryl, etc.) for t=0.1-10 hours, temperature T=20-200° C. and at speed of 1000-4000 rpm, and expandable agents: 2-60 wt. % expandable graphite (EG). The mixture is added either to a warm mixer or during transport of the viscous mass to the extruder using a flow-controlled dozer where the mixture homogenizes in the first zone: retention time 30 s-15 min at a temperature of 90-140° C., in the second zone 10 s-10 min at a temperature of 100-150° C. and in the third zone retention time 1 s-60 s at a temperature of 110-220° C. Forming of the material is done by using tools at the outlet of the extruder in order to obtain strips with a width of 20-400 mm.

In addition to the mentioned continuous process, the discontinuous process also takes place in two phases, where instead of a hot mixer a planetary mill is used in which the components are mixed in an analogous way according to the relations given as for the continuous process. In a phase (11) obtained mixture is transferred to the press at controlled temperature and pressure to obtain material in different dimensions: thickness 4-6 mm, width 20-400 mm and length 240-500 mm.

In relation to the known solutions from practice, the technological procedure is the optimal procedure for obtaining FEM at the laboratory and industrial level. The presented technologies of production of FEM represent the production of a product that is used for the production of collars for pipes as passive fire protection. In industrial production, after mixing the components in a hot mixer, the mixture goes to the extruder. The extruder has three temperature zones (40-70)-(70-90)-(90-120).

### Description of Schemes

Scheme 1. Procedure for obtaining intumescent material at the laboratory

Scheme 2. Procedure for obtaining intumescent material at industrial level

### DETAILED DESCRIPTION

Details of the present invention, with respect to processes for the preparation of fire-resistant material used to make pipe collars as passive fire protection can be found in the following examples without limiting the scope of the invention to those examples only.

### Example 1 Preparation of Levulinic Acid (4-oxovaleric Acid) (LK) by Dehydration of D-Fructose and LK Chloride (LKH)

In a 250 cm³ flask, 50 cm³ of 30% aqueous D-fructose solution was prepared. To adjust the pH to 0.46, 0.1 M hydrochloric acid (HCl) solution was added dropwise to the solution while stirring. After the pH was adjusted, the solution in the beaker was left to stir vigorously for a few minutes, and then transferred to a G10 microwave reactor vial (Monowave 300, Anton Paar). The reaction temperature was adjusted to 160° C. and maintained for 5 minutes while stirring (1000 rpm). After cooling, the contents of the vial were transferred to a 50 cm³ beaker, activated charcoal was added and, after stirring for 10 minutes, filtration was carried out to obtain a pale green solution. After removing the solvent by distillation, the levulinic acid as a white crystalline solid was obtained. Yield: 9.1 g, 94%. Molar mass: 116.12 g/mol. Acid number: 483.12. Melting point: 33° C. Boiling point: 245.5° C. The successfulness of a synthesis was demonstrated by NMR characterization: ¹H-NMR (400 MHz, DMSO-d₆, δ/ppm): 2.03 (s, 3H, C₅H₃), 2.55 (d, 2H, C₂H₂), 2.65 (d, 2H, C₃H₂), 11.15 (s, H, COOH); ¹³C-NMR (50 MHz, DMSO-d₆, δ/ppm): 30.2 (C₅), 39.2 (C₃), 40.3 (C₂), 198.1 (C₁), 205.7 (C₄).

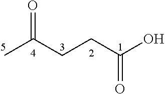

### Example 2 Synthesis of the Levulinic Acid Chloride (4-oxopentanoyl Chloride; LKH)

In a 500 ml flask equipped with a thermometer and condenser, 1 mol of levulinic acid (116 g) (Example 1) was dissolved in 150 ml of dry tetrahydrofuran (THF) and then it was immersed in an ice bath. Thionyl chloride (200 ml) was added dropwise while stirring and cooling. Then, the reaction is continued for another 6 hours while stirring in an oil bath at 70° C. Excess of thionyl chloride and THF were removed by vacuum distillation, and the product was also distilled in vacuum (50° C./2500 Pa) to obtain the product with as a pale-yellow oily liquid (125 g, 93% yield). Molar mass: 134.56 g/mol. Boiling point: 132° C. The successfulness of the synthesis was proven by NMR characterization: 1H-NMR (400 MHz, DMSO-d6, δ/ppm): 2.11 (s, 3H, C₅H₃), 2.78 (t, 2H, C₃H₂), 3.08 (d, 2H, C₂H₂); 13C-NMR (50 MHz, DMSO-d₆, δ/ppm): 30.2 (C₅), 39.2 (C₃), 40.3 (C₂), 172.1 (C₁), 206.4 (C₄).

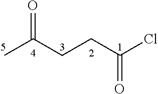

### Example 3 Synthesis of 5-methylfuran-2-carbonyl chloride (MFKH)

To a 500 ml flask equipped with a thermometer and condenser, 1 mol of 5-methylfuran-2-carboxylic acid (126 g) in 150 ml of dry tetrahydrofuran (THF) was added, followed by immersion in an ice bath. Thionyl chloride (200 ml) was added dropwise while stirring and cooling in an ice bath. Then, the reaction is continued for another 6 hours while stirring at 70° C. in an oil bath. Excess of thionyl chloride and THF were removed by a vacuum distillation. The product obtained (136 g, 94%) was a pale yellow oily liquid. Molar mass: 144.55 g/mol. The successfulness of the synthesis was proven by NMR characterization: ¹H-NMR (400 MHz, DMSO-d₆, δ/ppm): 2.32 (s, 3H, C₆H₃), 6.46 (d, 1H, C₄H), 7.51 (d, 2H, C₃H); ¹³C-NMR (50 MHz, DMSO-d₆, δ/ppm): 13.1 (C₆), 108.2 (C₄), 122.8 (C₃), 144.2 (C₂), 152.2 (C₁), 158.8 (C₅).

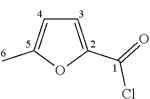

### Example 4 Synthesis (5-metilfuran-2-yl)metanol (5-metilfuril Alcohol; MFA)

To a 500 ml flask equipped with a thermometer and condenser, 1 mol of 5-methylfuran-2-carboxylic acid (126 g) in 150 ml of dry tetrahydrofuran (THF) was added, followed by immersion in an ice bath. Sodium borohydride (1 mol) is added in portions with stirring and cooling in an ice bath. Thereafter, the reaction was continued for another 6 hours while stirring at 65° C. in an oil bath. Excess of THF (¾ volume) was removed by vacuum distillation and the residue was poured into 50 ml of cold deionized water (saturated with sodium chloride). The product was extracted with ether. The product obtained (105.2 g, 94%) was a pale-yellow oily liquid. Molar mass: 112 g/mol. The successfulness of the synthesis was proven by NMR characterization: ¹H-NMR (400 MHz, DMSO-d₆, δ/ppm): 2.18 (s, 3H, C₆H₃), 4.35 (s, 2H, C₁H₂), 4.89 (s, 1H, OH), 5.99 (d, 1H, C₄H), 6.28 (d, 1H, C₃H); ¹³C-NMR (50 MHz, DMSO-d₆, δ/ppm): 13.6 (C₆), 57.1 (C₁); 106.2 (C₄), 107.2 (C₃), 152.8 (C₅), 153.7 (C₂).

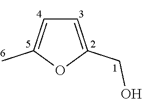

### Example 5 Synthesis of 5-(chloromethyl)furan-2-carbonyl chloride (5-HMFKH)

5-(chloromethyl)furfural (2.226 g, 15.40 mmol) and tert-butyl hypochlorite (10.5 mL, 10.1 g, 92.7 mmol) were introduced into a 50 mL round bottom flask wrapped in aluminum foil. The mixture was stirred rapidly at room temperature under air. After 24 hours, the measured amount of 1,4-dioxane was added as an internal standard and the yield of 5-(chloromethyl) furan-2-carbonyl chloride was determined at 85% ¹H NMR by peak integration. The successfulness of the synthesis was proven by NMR characterization: ¹H-NMR (400 MHz, DMSO-d₆, δ/ppm): 4.48 (s, 2H, C₆H₂), 6.42 (d, 1H, C₃H), 7.68 (d, 1H, C₄H); ¹³C-NMR (50 MHz, DMSO-d₆, δ/ppm): 45.6 (C₆), 107.6 (C₄); 122.2 (C₃), 144.2 (C₂), 151.8 (C₁), 156.7 (C₅).

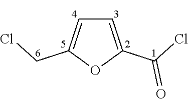

### Example 6 Synthesis of furan-2,5-dicarbonyl chloride

To a 500 ml flask equipped with a thermometer, condenser with a protective calcium chloride tube and a dropping funnel, 1 mol of 2,5-furandicarboxylic acid (156 g) was added in 150 ml of dry tetrahydrofuran (THF), which is then immersed in an ice bath. Thionyl chloride (150 ml) was added dropwise while stirring and cooling in an ice bath. Then, the reaction is continued for another 6 hours while stirring at 70° C. in an oil bath. Excess of thionyl chloride and THF are removed by vacuum distillation. The resulting product (172 g, 89.6%) was a pale yellow oily liquid. Molar mass: 191.94 g/mol. The successfulness of the synthesis was proven by NMR characterization: ¹H-NMR (400 MHz, DMSO-d₆, δ/ppm): 8.18 (s, 2H, C₃H i C_{3′}H); ¹³C-NMR (50 MHz, DMSO-d₆, δ/ppm): 123.8 (C₃ i C_{3′}), 150.4 (C₂ i C_{2′}), 151.7 (C₁ i C_{1′}).

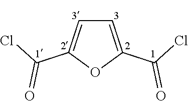 [SMILES: O=C(Cl)c1ccc(C(=O)Cl)o1]

### Example 7 Synthesis of bis(5-methylfuran-2-yl) methyl) furan-2,5-dicarboxylate (bMFFDK)

To a 500 ml flask, equipped with a thermometer and condenser, 0.5 mol of furan-2,5-dicarbonyl chloride (96 g) in 100 ml of dry tetrahydrofuran (THF) was added, followed by immersion in an ice bath. To the solution was added dropwise 0.5 mol (5-methylfuran-2-yl) methanol (56 g) and 1 mol triethylamine (101.2 g) over 30 min while cooling in an ice bath. Thereafter, the reaction was continued for another 6 hours with stirring at room temperature and for 2 hours at 60° C. in an oil bath. Excess of THF and unreacted reagents were removed by vacuum distillation. Then, the product was washed three times with deionized water, dried with sodium sulfate. The product obtained (151 g, 87.8%) was in the form of a pale yellow oily liquid. Molar mass: 344.1 g/mol. The successfulness of the synthesis was proven by NMR characterization: ¹H-NMR (400 MHz, DMSO-d₆, δ/ppm): 2.22 (s, 6H, C₉H₃ i C_{9′}H₃), 6.45 (s, 4H, C₄H i C_{4′}H), 6.12 (d, 2H, C₇H i C_{7′}H), 6.32 (d, 2H, C₆H i C_{6′}H), 7.82 (d, 2H, C₃H i C_{3′}H); ¹³C-NMR (50 MHz, DMSO-d₆, δ/ppm): 13.4 (C₉ i C_{9′}), 56.7 (C₄ i C_{4′}), 106.2 (C₇ i C_{7′}), 107.4 (C₆ i C_{6′}), 119.2 (C₃ i C_{3′}), 138.2 (C₅ i C_{5′}), 147.6 (C₂ i C_{2′}), 152.8 (C₈ i C_{8′}), 158.7 (C₁ i C_{1′}).

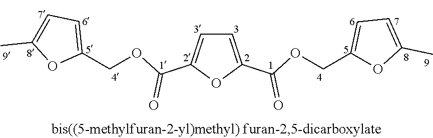

### Example 8 Synthesis of furan-2,5-diylbis (methylene) bis (furan-2-carboxylate) (FDAbFDK)

In the first step, furan-2,5-diyldimethanol (FdA) is obtained: 1 mol of 2,5-furandicarboxylic acid (156 g) in 150 ml of dry tetrahydrofuran (THF) was added to a 500 ml flask equipped with a thermometer, a condenser with a protective calcium chloride tube and a dropping funnel, and then it was immersed in an ice bath. Lithium aluminum hydride 2.2 mol (83.5 g/mol) was added dropwise with stirring and cooling in an ice bath (<5° C.). Thereafter, the reaction was continued for another 12 hours at room temperature and for 12 hours at 50° C. in an oil bath. After cooling, the reaction mixture was filtered while maintaining an inert atmosphere. The solution was then transferred to an identical dry apparatus as the one used to reduce FDK. 1 mol of triethylamine (101.2 g) was added to the solution during 30 min. The temperature was decreased to <5° C. and MFKH (Example 3) was added during 1 h. The reaction was continued for 10 hours at room temperature and for 6 hours at 50° C. Excess of THF and unreacted reagents were removed by vacuum distillation, the product was washed three times with deionized water, dried with sodium sulfate. The product obtained (282 g, 89.2%) was a pale yellow oily liquid. Molar mass: 316.1 g/mol. The successfulness of the synthesis was proven by NMR characterization: ¹H-NMR (400 MHz, DMSO-d₆, δ/ppm): 2.32 (s, 6H, C₉H i C_{9′}H), 5.34 (s, 2H, C₁H i C_{1′}H), 6.32 (s, 2H, C₃H i C_{3′}H), 6.56 (d, 2H, C₇H i C_{7′}H), 7.05 (s, 2H, C₆H i C_{6′}H), ¹³C-NMR (50 MHz, DMSO-d₆, δ/ppm): 13.2 (C₉ i C_{9′}), 56.4 (C₁ i C_{1′}), 108.2 (C₇ i C_{7′}), 109.4 (C₆ i C_{6′}), 139.2 (C₂ i C_{2′}), 142.2 (C₅ i C_{5′}), 158.4 (C₄ i C_{4′}), 159.2 (C₈ i C_{8′}).

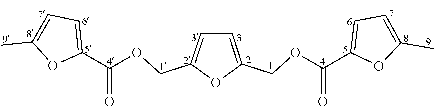

### Example 9 Synthesis of furan-2,5-diylbis(methylene)bis(4-oxopentanoate) (FDA-b-LK)

In an analogous manner to Example 8, the synthesis of furan-2,5-diylbis (methylene) bis (4-oxopentanoate) was performed. The product obtained (276 g, 85.2%) was a pale yellow oily liquid. Molar mass: 324.1 g/mol. The successfulness of the synthesis was proven by NMR characterization: ¹H-NMR (400 MHz, DMSO-d₆, δ/ppm): 2.12 (s, 6H, C₈H i C_{8′}H), 2.68 (s, 4H, C₆H i C_{6′}H), 2.85 (s, 4H, C₅H i C_{5′}H), 5.14 (d, 4H, C₁H i C_{1′}H), 6.38 (d, 2H, C₃H i C_{3′}H); ¹³C-NMR (50 MHz, DMSO-d₆, δ/ppm): 29.2 (C₈ i C_{8′}), 27.4 (C₅ i C_{5′}), 37.4 (C₆ i C_{6′}), 61.2 (C₁ i C_{1′}), 107.6 (C₃ i C_{3′}), 139.2 (C₂ i C_{2′}), 172.8 (C₄ i C_{4′}), 207.5 (C₇ i C_{7′}).

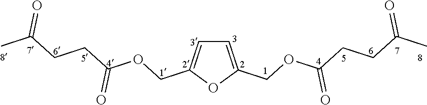 [SMILES: CC(=O)CCC(=O)OCc1ccc(COC(=O)CCC(C)=O)o1]

### Example 10 Modification of VC-co-VAc Copolymer Using LKH (VC-co-VAc-co-VOLK)

The synthesis of VC-co-VAc-co-VOLK terpolymers is performed in two phases.

First phase—partial hydrolysis of VC-co-VAc copolymer: Partial hydrolysis was performed by dissolving 500 g of VC-co-VAc copolymer (Slovinyl KV 173) in 10 l of dimethylacetamide (DMAc) at 120° C. in an inert nitrogen atmosphere (N₂). After 30 minutes, alcoholic sodium hydroxide (0.5 M NaOH/EtOH) was added when the measurement time required for 85% hydrolysis of the acetate groups begins (2.2 hours). After completion of the hydrolysis, the solution was precipitated in methanol with vigorous stirring (1000 rpm). After filtration, the purification process was repeated. The partially hydrolyzed VC-co-VAc-co-VOH polymer was dissolved in DMAc, precipitated in methanol, filtered and dried at 60° C. for 8 hours in vacuum. Second phase of modification—reactions of VC-co-VAc-co-VOH copolymer with levulinic acid chloride (LKH; Example 2): After dissolving 500 g of VC-co-VAc-co-VOH polymer in 10 l DMAc, 62 g of triethylamine are added. Then, 70 g of LKH dissolved in 500 ml of DMAc was slowly added dropwise during 30 min at 5-10° C. After completion of the reaction, the solution was precipitated in methanol with vigorous stirring (1000 rpm). After filtration, another purification of terpolymer VC-co-VAc-co-VOLK from salt was performed. The VC-co-VAc-co-VOLK polymer was dissolved in DMAc, precipitated in methanol, filtered and dried at 60° C. for 8 hours in vacuum.

The successfulness of the synthesis was proven by quantitative determination of the ratio of selected peaks in order to quantify the implemented modifications: ¹H-NMR (400 MHz, DMSO-d₆, δ/ppm): the ratio of the peak integrals to 1 (CH₂—CHCl) and 1.71 (CH₂—CHOLK) as well as the ratio of peak integrals at 1.55 ppm (CH₂—CHl) and 4.44 (CH₂—CHOLK). The analysis indicated that the modification performed was 81% (8.3% present vinyl alcohol segment modified with LKH). ¹³C-NMR (50 MHz, DMSO-d₆, δ/ppm): 13 C-NMR (50 MHz, DMSO-d 6, δ/ppm): ratio of peak integrals at 31 ppm (CH2-CHl) and 65.4 (CH₂-CHOLK) (or 173.4 ppm carbonyl carbon of the LK residue) as well as peak integrals at 31 ppm (CH₂—CHl) and 70.1 (CH₂—CHOAc) (or 170.4 ppm carbonyl carbon of the acetyl group) indicated that the modification performed was 80% (8.2% present vinyl alcohol segment modified with LKH).

### Example 11 Modification of VC-co-VAc Copolymer Using MFKH (VC-co-VAc-co-VOMFK)

In an analogous manner to Example 10, the VC-co-VAc copolymer was modified with 5-methylfuran-2-carbonyl chloride (MFKH; Example 4). The successfulness of the synthesis was proven by quantitative determination of the ratio of selected peaks in order to quantify the performed modifications: ¹H-NMR (400 MHz, DMSO-d6, δ/ppm): the ratio of peak peaks at 1.55 ppm (CH₂—CHl) and 1.90 (CH₂—CHOMFK) as well as the ratios of the peak integrals at 1.55 ppm (CH₂—CHl) and 4.42 (CH₂—CHOMFK) (as well as the doublet at 6.5 of MFK), which indicated that the modification performed was 79% (8.15% MFKH-modified vinyl acetate segment (VAc). ¹³C-NMR (50 MHz, DMSO-d6, δ/ppm): peak integral ratio at 31 ppm (CH₂—CHl) and 62.4 ppm (CH₂-CHOMFK) (or 161 ppm of carbonyl ester group from MFK) as well as the ratio of the peak integrals to 31 ppm (CH₂—CHl) and 71.6 (CH₂—CHOAc) (or 170.4 ppm of carbonyl carbon of acetyl group) indicate that the modification was performed 78% (8.0% present with vinyl alcohol segment modified with MFKH).

### Example 12 “Live” Polymerization (ATRP Method)

“Live” polymerization (ATRP—by the atomic transfer free radical polymerization) was performed in two phases.

Phase 1: 270 g of partially hydrolyzed VC-co-VAc-co-VOH copolymer was dissolved in 1350 g (1560 mL) of DMAc in a flask. After complete dissolution, 1.25 g of N,N-dimethylaminopyridine (0.05 equivalents to the hydroxyl groups in VC-co-VAc-co-VOH), 22.8 g of triethylamine (1.21 equivalents) were added. The balloon was cooled in an ice bath to 0° C. Chloroacetyl chloride (23.2 g-1.0 equivalent) was dissolved in toluene and added dropwise to a solution of the partially hydrolyzed copolymer of ethylene and vinyl acetate (EVAOH) with stirring. The reaction was left for 24 hours to achieve complete conversion. The product obtained is precipitated by pouring into cold methanol. The precipitate was filtered off and dried under vacuum at 60° C. for 8 hours. A light yellow product was obtained VC-co-VAc-co-VOAcCl.

Phase II: “Live” polymerization (ATRP) was performed in an inert nitrogen atmosphere in a dry apparatus with magnetic stirring. 50 g of VC-co-VAc-co-VOAcCl (calculated to theoretically have 0.00205 mol/g Cl) in 4 ml of toluene were added to the flask. After complete dissolution with stirring, 10.2 g of CuCl (1 molar equivalent relative to bound Cl), 48.0 g of bipyridine (3 molar equivalents relative to bound Cl) were added, which was dissolved in 500 ml of toluene. Then 13.5 ml of ethyl acrylate EtA was added. The system was degassed to remove residual oxygen, after which the balloon was immersed in an oil bath at 80° C. The conversion was followed by extraction of 0.1 ml of the reaction mixture into a vial with 5 ml of methanol. The product VC-co-VAc-co-VOAc(EtA)n was obtained.

The successfulness of the synthesis was proved by quantitative determination of the ratio of selected peaks in order to quantify the performed modifications: ¹H-NMR (400 MHz, DMSO-d₆, δ/ppm): the ratio of peak peaks at 1.55 ppm (CH2-CHl) and 1.71 (CH₂—CHOAc(EtA)ₙ) as well as the ratios of the peak integrals at 1.55 ppm (CH₂—CHl) and 4.46 (CH₂—CHOAc(EtA)ₙ) (or 4.21 ppm CH₃CH₂OC═O from EtA), which indicated that the modification was performed 72% (7.4% of the present graft poly (ethyl acrylate) segment homopolymer). ¹³C-NMR (50 MHz, DMSO-d₆, δ/ppm): ratio of peak integrals at 31 ppm (CH₂—CHl) and 66.0 ppm (CH₂—CHOAc(EtA)ₙ (or 175.4 ppm of carbonyl ester carbon) groups from EtA) as well as the ratios of the peak integrals at 31 ppm (CH₂—CHl) and 68.1 (CH₂—CHOAc) (or 170.2 ppm carbonyl carbon of the acetyl group), which indicated that the modification performed was 74% (7.50% present vinyl alcohol segment modified with MFKH).

Production of FEM using plasticizers given in Examples 7-9 and binders described in Examples 10-12

### Example 13 Preparation of Copolymer-Based Materials (VC-co-VAc) (Slovinyl KV 173)

VC-co-VAc copolymer (30% by weight) and plasticizers/modifiers such as DINP (15% by weight), DOA (10% by weight), ADC (0.4% by weight) were added to the hot mixer. TKP (10 wt. %), ESO (3 wt. %) and stirred for t=2 hours at temperature T=110° C. and speed 3200 rpm. Expandable agents: 32 wt. % expandable graphite (EG), 0.2 wt. % of MES (or 1-hexadecene, MESO, MELO, MESuO or MECO), 0.4 wt. % of azodicarbonamide (ADC) and 2.5 wt. % of polyacrylate or poly(vinyl acetate) emulsion (Ecrylic, Flexryl or DH50, etc.) were added during transport of the viscous mixture to the extruder using a flow-controlled dispenser where it was homogenized in the first zone: retention time 2 min at 98° C., in the second zone 1 min at 122° C. and the third zone retention time 30 s at 172° C. The profiling of the material was done using tools at the outlet of the extruder in order to obtain strips with a width of 50 mm. In an analogous manner to Example 13, a material was obtained using a plasticizer of 15 wt. % bMFFDK (Example 13/1), 15 wt. % of FDAbFDK (Example 13/2) and 15 wt. % of FDA-b-LK (Example 13/3). as a substitute for DINP, 25 wt. % bMFFDK (Example 13/4), 25 wt. % FDAbFDK (Example 13/5) and 25 wt. % FDA-b-LK (Example 13/6) as a substitute for DINP and DOA, 35 wt. % bMFFDK (Example 13/7), 35 wt. % FDAbFDK (Example 13/8) and 35 wt. % FDA-b-LK (Example 13/9) as a substitute for DINP, DOA and TKP. The control sample was prepared in an analogous manner to Example 13 using 35% DINP plasticizers (Example 13/10), as well as the sample with DINP: bio plasticizers at a weight ratio of 1:1 (Examples 13/11-13).

The use of 1-hexadecene or MESO, MELO, MESuO or MEKO gave completely identical results and the following examples refer to the use of MESU. The results of tests of mechanical properties, specific weight and resistance to combustion are given in Tables 1 and 2.

### Example 14 Preparation of PVC-Based Materials K70

A PVC K70 copolymer (30 wt. %) was added to the hot mixer and FEM material was added analogously to Example 13. A material was obtained using a plasticizer of 15 wt. % bMFFDK (Example 14/1), 15 wt. % of FDAbFDK (Example 14/2) and 15 wt. % of FDA-b-LK (Example 14/3). as a substitute for DINP, 25 wt. % bMFFDK (Example 14/4), 25 wt. % FDAbFDK (Example 14/5) and 25 wt. % FDA-b-LK (Example 14/6) as a substitute for DINP and DOA, 35 wt. % BMFFDK (Example 14/7), 35 wt. % FDAbFDK (Example 14/8) and 35 wt. % FDA-b-LK (Example 14/9) as a substitute for DINP, DOA and TKP. The control sample was prepared in an analogous manner to Example 14 using 35% DINP plasticizers (Example 14/10), as well as the sample with DINP: bio plasticizers at a weight ratio of 1:1 (Examples 14/11-13).

The results of tests of mechanical properties, specific weight and resistance to combustion are given in Tables 1 and 2.

### Example 15 Preparation of Copolymer-Based Materials (VC-co-VAc-co-VOLK) (Example 10)

The polymer VC-co-VAc-co-VOLK (30 wt. %) was added to the hot mixer and FEM material was obtained analogously to Example 13. The material was obtained using a plasticizer of 15 wt. % bMFFDK (Example 15/1), 15 wt. % of FDAbFDK (Example 15/2) and 15 wt. % of FDA-b-LK (Example 15/3) as a substitute for DINP, 25 wt. % bMFFDK (Example 15/4), 25 wt. % FDAbFDK (Example 15/5) and 25 wt. % FDA-b-LK (Example 15/6) as a substitute for DINP and DOA, 35 wt. % bMFFDK (Example 15/7), 35 wt. % FDAbFDK (Example 15/8) and 35 wt. % FDA-b-LK (Example 15/9) as a substitute for DINP, DOA and TKP. The control sample was prepared in an analogous manner to Example 15 using 25% DINP plasticizers (Example 15/10), as well as the sample with DINP: bioplasticizers at a fat ratio of 1:1 (Examples 15/11-13). The results of tests of mechanical properties, specific weight and resistance to combustion are given in Tables 1 and 2.

### Example 16 Preparation of Copolymer-Based Materials (VC-co-VAc-co-VOMFK) (Example 11)

The copolymer VC-co-VAc-co-VOMFK (30 wt. %) was added to the hot mixer and FEM material was obtained analogously to Example 13. In an analogous manner to Example 16, a material was obtained using a plasticizer of 15 wt. % bMFFDK (Example 16/1), 15 wt. % of FDAbFDK (Example 16/2) and 15 wt. % of FDA-b-LK (Example 16/3). as a substitute for DINP, 25 wt. % bMFFDK (Example 16/4), 25 wt. % FDAbFDK (Example 16/5) and 25 wt. % FDA-b-LK (Example 16/6) as a substitute for DINP and DOA, 35 wt % bMFFDK (Example 16/7), 35 wt % FDAbFDK (Example 16/8) and 35 wt % FDA-b-LK (Example 16/9) as a substitute for DINP, DOA and TKP. The control sample was prepared in an analogous manner to Example 16 using 35% DINP plasticizers (Example 16/10), as well as the sample with DINP: bioplasticizers at a fat ratio of 1:1 (Examples 16/11-13). The results of tests of mechanical properties, specific weight and resistance to combustion are given in Tables 1 and 2.

### Example 17 Preparation of Copolymer-Based Material (VC-co-VAc-co-VOAc (EtA) n) (Example 12)

The polymer VC-co-VAc-co-VOAc (EtA) n (30 wt. %) was added to the hot mixer and FEM material was obtained analogously to Example 13. The material was obtained using a plasticizer of 15 wt. % bMFFDK (Example 17/1), 15 wt. % of FDAbFDK (Example 17/2) and 15 wt. % of FDA-b-LK (Example 17/3) as a substitute for DINP, 25 wt. % bMFFDK (Example 17/4), 25 wt. % FDAbFDK (Example 17/5) and 25 wt. % FDA-b-LK (Example 17/6) as a substitute for DINP and DOA, 35 wt. % BMFFDK (Example 17/7), 35 wt. % FDAbFDK (Example 17/8) and 35 wt. % FDA-b-LK (Example 17/9) as a substitute for DINP, DOA and TKP. The control sample was prepared in an analogous manner to Example 17 using 35% DINP plasticizers (Example 17/10), as well as the sample with DINP: bioplasticizers at a fat ratio of 1:1 (Examples 17/11-13). The results of tests of mechanical properties, specific weight and resistance to combustion are given in Tables 1 and 2.

### Example 18 Preparation of Materials Based on a Combination of Binders

In an analogous manner to Example 13, FEM materials were obtained using 30 wt. % of binder at the following ratios: PVC K70: (VC-co-VAc) (Slovinyl KV 173) 1:1 (Example 18), PVC K70: (VC-co-VAc) (Slovinyl KV 173) 0.75:0.25 (Example 18/1), PVC K70: (VC-co-VAc) (Slovinyl KV 173) 0.25:0.75 (Example 18/2), PVC K70:VC-co-VAc-co-VOLK) 1:1 (Example 18/3), PVC K70: VC-co-VAc-co-VOLK) 0.75:0.25 (Example 18/4), PVC K70: VC-co-VAc-co-VOLK (0.25:0.75) (Example 18/5), PVC K70: (VC-co-VAc-co-VOMFK) 1:1 (Example 18/6), PVC K70: (VC-co-VAc-co-VOMFK) 0.75:0.25 (Example 18/7), PVC K70: (VC-co-VAc-co-VOMFK) 0.25:0, 75 (Example 18/8), PVC K70: (VC-co-VAc-co-VOAc (EtA) n) 1:1 (Example 18/9), PVC K70: (VC-co-VAc-co-VOAc) EtA) n) 0.75:0.25 (Example 18/10), PVC K70: (VC-co-VAc-co-VOAc (EtA) n) 0.25:0.75 (Example 18/11), (VC-co-VAc):VC-co-VAc-co-VOLK) 1:1 (Example 18/12), (VC-co-VAc): VC-co-VAc-co-VOLK) 0.75:0.25 (Example 18/13), (VC-co-VAc):VC-co-VAc-co-VOLK) 0.25:0.75 (Example 18/14), (VC-co-VAc):(VC-co-VAc-co-VOMFK) 1:1 (Example 18/15), (VC-co-VAc):(VC-co-VAc-co-VOMFK) 0.75:0.25 (Example 18/16), (VC-co-VAc):(VC-co-VAc-co-VOMFK) 0.25:0.75 (Example 18/17), (VC-co-VAc):(VC-co-VAc-co-VOAc (EtA)n) 1:1 (Example 18/18), (VC-co-VAc):(VC-co-VAc-co-VOAc (EtA)n) 0.75:0.25 (Example 18/19), (VC-co-VAc):(VC-co-VAc-co-VOAc (EtA)n) 0.25:0.75 (Example 18/20).

The results of tests of mechanical properties, specific weight and resistance to combustion are given in Tables 1 and 2.

Characterization Methods

The hardness of the obtained material was measured using Shore A tester.

The specific gravity was calculated based on the mass and volume of the sample. In the case of a body of a regular shape, the volume is determined by calculation, but the lengths of the pages are previously measured with a ruler or a vernier. The volume of a square is calculated by the formula V=a·b·c, so the density of the sample is calculated by the formula ρ=m/V (g/cm³). Elemental analysis was performed on an ELEMENTAR Vario EL III CHNS/O analyzer. ¹H and ¹³C NMR spectra were recorded in DMSO-d₆ using a Bruker Avance 111 500 spectrometer. Chemical shifts are given relative to tetramethylsilane (TMS).

The toughness test of composite materials by the Charpy method was performed according to the standard EN ISO 179-1/1fU on the Zwick & Co device. KG., Germany. The characteristics of the device are: pendulum weight 1.983 kg (150 kgcm), pendulum length 39.0 cm and drop length 75.648 cm. Therefore, the impact speed of the samples with limited ends was 3.85 m/s. From each group, three samples were taken for measurements, and the results were presented as the mean values of three different measurements under atmospheric conditions (21° C.).

The tensile strength of the samples was measured using a servo-hydraulic testing machine INSTRON1332 (Instron Ltd., USA) with control electronics FASTtrack 8800. The tensile speed is 5 mm/min. All samples had same dimensions.

The fire-resistance of materials was tested according to the non-combustibility standards AS/NZS 1530.3: 1999 and AS 1530.4-2005.

Test Results of the Obtained Materials

TABLE 1
Results of hardness and specific density of obtained materials

| | Hardness | Specific density, | Expansion coefficient, |
|---|---|---|---|
| Example | (Shore A) | g/cm³ | 10⁻⁵/K |
| Example 13 | 30 ± 2.5 | 1.102 | 5 |
| Example 13/1 | 32 ± 2.6 | 1.005 | 6 |
| Example 14 | 45 ± 1.7 | 0.968 | 3 |
| Example 14/1 | 48 ± 1.3 | 0.889 | 4 |
| Example 15 | 43 ± 2.3 | 0.998 | 6 |
| Example 15/1 | 44 ± 2.6 | 0.977 | 8 |
| Example 16 | 38 ± 1.3 | 0.889 | 6 |
| Example 16/1 | 40 ± 1.6 | 0.959 | 7 |
| Example 17 | 34 ± 2.1 | 0.985 | 5 |
| Example 17/1 | 35 ± 2.2 | 0.932 | 6 |
| Example 18 | 36 ± 2.5 | 1.035 | 4 |
| Example 18/3 | 44 ± 1.8 | 0.943 | 4 |
| Example 18/6 | 42 ± 1.5 | 0.929 | 4 |
| Example 18/9 | 39 ± 1.9 | 0.976 | 4 |
| Example 18/12 | 37 ± 2.4 | 1.050 | 5 |
| Example 18/15 | 34 ± 1.9 | 0.995 | 5 |
| Example 18/18 | 32 ± 2.3 | 1.043 | 5 |

*Test results for hardness and specific gravity of samples obtained according to Examples 13/2-13, Examples 14/2-10, Examples 15/2-13, Examples 16/2-13, Examples 17/2-13, Examples 18/1-2, Examples 18/4-5, Examples 18/7-8, Examples 18/10-11, Examples 18/13-14, Examples 18/6-17, Examples 18/19-20 confirm the success of obtaining fire-resistant materials with values within the limits of differences up to 10% in relation to the corresponding samples shown in Table 1.

TABLE 2
Results of mechanical properties of the obtained materials

| | | | Absorbed energy |
|---|---|---|---|
| | | | determined by the |
| | | | Charpy method, |
| Example | σ, Mpa | ε, % | W (kJ/m²) |
| Example 13 | 23 ± 3.1 | 11.8 ± 0.09 | 70 |
| Example 13/1 | 28 ± 2.7 | 9.5 ± 0.05 | 90 |
| Example 14 | 43 ± 1.6 | 5.1 ± 0.03 | 150 |
| Example 14/1 | 45 ± 1.6 | 6.1 ± 0.03 | 158 |
| Example 15 | 38 ± 1.8 | 8.5 ± 0.08 | 129 |
| Example 15/1 | 39 ± 1.7 | 8.8 ± 0.09 | 130 |
| Example 16 | 36 ± 2.4 | 8.8 ± 0.07 | 125 |
| Example 16/1 | 36 ± 2.4 | 8.8 ± 0.07 | 125 |
| Example 17 | 33 ± 2.7 | 9.5 ± 0.05 | 118 |
| Example 17/1 | 35 ± 2.1 | 9.8 ± 0.07 | 120 |
| Example 18 | 33 ± 2.3 | 8.4 ± 0.06 | 110 |
| Example 18/3 | 40 ± 1.7 | 6.8 ± 0.05 | 139 |
| Example 18/6 | 39 ± 2.0 | 6.9 ± 0.05 | 136 |
| Example 18/9 | 37 ± 2.2 | 7.1 ± 0.08 | 132 |
| Example 18/12 | 31 ± 2.5 | 10.1 ± 0.09 | 100 |
| Example 18/15 | 28 ± 2.8 | 10.4 ± 0.08 | 97 |
| Example 18/18 | 25 ± 2.9 | 10.7 ± 0.06 | 94 |

* Results of tensile strength and adsorbed energy tests of samples obtained according to Examples 13/2-9 and 13/10, Examples 14/2-8, Examples 15/2-10, Examples 16/2-10, Examples 17/2-10, Examples 18/1-2, Examples 18/4-5, Examples 18/7-8, Examples 18/10-11, Examples 18/13-14, Examples 18/16-17, Examples 18/19-20 confirm the success obtaining fire-retardant materials with values in the range of differences up to 10% in relation to the corresponding samples shown in Table 2.

All obtained samples were tested according to non-combustibility standards (AS/NZS 1530.3: 1999 and AS 1530.4-2005). The samples behaved according to the prescribed standards, stopped the flow of air and the spread of fire for 3 hours, when the experiment was stopped. All presented samples meet the criteria prescribed by the standards.

1. A new two-stage process for the production of flexible expandable fire-resistant materials (FEM), where in Phase (I) polyvinyl chloride (PVC K70) binders, poly(vinyl chloride-co-vinyl acetate) copolymers (VC-co-VAc) or modified poly(vinyl chloride-co-vinyl acetate) copolymer (m-VC-co-VAc:VC-co-VAc-co-VOMFK, VC-co-VAc-co-VOLK, VC-co-VAc-co-VOAc (EtA) n) are mixed at the laboratory and industrial level with plasticizers/modifiers such as plasticizers: diisononyl phthalate—DINP, diisononyl terephthalate—DINTP, dioctyl adipate—DOA, tri-p-cresyl phosphate (TpKP), tri-m-cresyl phosphate (TmKP), tri-o-cresyl phosphate (ToKP) or mixtures thereof, epoxidized soybean oil (ESO), as well as synthesized on the basis of bioreneable sources such as: bis (5-methylfuran-2-yl)methyl) furan-2,5-dicarboxylate (b-MFFDK), furan-2,5-diylbis(methylene)bis(furan-2-carboxylate) (FDA-b-FDK), furan-2,5-diylbis (methylene)bis(4-oxopentanoate) (FDA-b-LK), stabilizers, 1-hexadecen or methyl esters of soybean oil—MES or flaxseed (MELO) or sunflower (MESuO) or corn oil (MECO), azodicarbonamide (ADC), melamine, as well as polyacrylate or polyvinyl acetate emulsions (Ecrylic, Flexryl or DH50 etc.) in a hot mixer until homogeneity and plasticity are achieved, and then the expandable agents: expandable graphite (EG) are added either to the hot mixer or during transport of the viscous mixture to the extruder using a controlled flow dozer where the mixture was homogenized according to defined technology and the material was profiled using tools at the outlet of the extruder in order to obtain strips 20-400 mm wide and 2-10 mm thick.

2. The process according to claim 1, where the FEM production process is carried out using 10-50% by weight of polyvinyl chloride (PVC K70), a modified copolymer of poly(vinyl chloride-co-vinyl acetate) (m-VC-co-VAc:VC-co-VAc-co-VOMFK, VC-co-VAc-co-VOLK, VC-co-VAc-co-VOAc(EtA) n) as binders or their two-component mixtures at mass ratios of PVC K70: m-VC-co-VAc 0.1:1-1:0.1.

3. The process according to claim 1, where the FEM production process is carried out using 10-50% by weight of a poly (vinyl chloride-co-vinyl acetate) copolymer (VC-co-VAc) or in a mixture with PVC K70 at weight ratios 0.1:1-1:0.1 as binder.

4. The process according to claim 1, where the FEM production process is carried out using 10-50% by weight of copolymers of poly (vinyl chloride-co-vinyl acetate)(VC-co-VAc) in two-component mixtures with modified copolymers of poly(vinyl chloride-co-vinyl acetate) (m-VC-co-VAc:VC-co-VAc-co-VOMFK, VC-co-VAc-co-VOLK, VC-co-VAc-co-VOAc(EtA)n) at mass VC-co-VAc: m-VC-co-VAc ratios of 0.1:1-1:0.1.

5. The process according to claim 1, where the FEM production process is carried out in a hot mixer by mixing binders with 5-40% by weight of plasticizers/modifiers such as phthalate plasticizers diisononyl phthalate—DINP, diisononyl terephthalate—DINTP, 0-20 wt % dioctyl adipate—DOA, 0-20 wt. % tri-p-cresyl phosphate (TpKP), tri-m-cresyl phosphate (TmKP), tri-o-cresyl phosphate (ToKP), 0-10 wt. % epoxidized soybean oil (ESO) or mixtures thereof at mass ratios of components in a mixture of 0.1:1-1:0.1.

6. The process according to claim 1, where the process for the production of FEM is carried out in a warm mixer by mixing a binder with 5-40% by weight of bis(5-methylfuran-2-yl)methyl) furan-2,5-dicarboxylate (b-MFFDK) or furan-2,5-diyl bis(methylene)bis(furan-2-carboxylate)(FDA-b-FDK) or furan-2,5-diyl bis(methylene)bis(4-oxopentanoate) (FDA-b-LK), as well as their mixtures with phthalate plasticizers at mass ratios 01: 1-1:0.1.

7. The process according to claim 1, where the process of production of FEM material is performed in a warm mixer during a time of t=0.1-10 hours, temperature T=20-200° C. and speed 1000-4000 rpm.

8. The process according to claim 1, where the process of production of FEM in Phase II is performed in an extruder and the processing of homogeneous mixture obtained in the first phase according to the following technology: first zone retention time 30 s-15 min, temperature 90-140° C., second zone 10 s-10 min, temperature 100-150° C. and the third zone retention time 1 s-60 s, temperature 110-220° C.

9. A method according to claim 1, where the obtained FEM materials have Shore hardness values 30-48, specific gravity 0.889-1.102 g/cm³, expansion coefficient 3-8 10⁵/K, tensile strength (σ) 23-43 MPa, unit elongation (ε) 5.1-11.8%, Charpy toughness (W) 70-158 kJ/m² and fire-resistance for more than 3 hours as defined by AS/NZS 1530.3: 1999 and AS 1530.4-2005.

10. A method of use of a FEM material obtained according to claim 1, as a passive fire-resistant material used to prevent the spread of flame and air flow in openings and ducts by creating expandable barriers which serve to insulate the flame source.
